(19) United States
(12) Patent Application Publication
(10) Pub. No.: US 2020/0099248 A1
(43) Pub. Date: Mar. 26, 2020

(54) Controlled Low Voltage Emergency Power Distribution

(71) Applicant: Eaton Intelligent Power Limited, Dublin (IE)

(72) Inventors: James Christopher Andrews, Mableton, GA (US); Brian Soderholm, Peachtree City, GA (US)

(21) Appl. No.: 16/578,865

(22) Filed: Sep. 23, 2019

Related U.S. Application Data
(60) Provisional application No. 62/734,599, filed on Sep. 21, 2018.

(51) Int. Cl. H02J 9/00; H02J 9/02

(52) U.S. Cl. CPC H02J 9/002; H02J 9/02

(57) ABSTRACT

A hybrid distributed low voltage power system can include a primary power source that distributes a first low voltage (LV) energy during a first mode of operation to a plurality of first LV devices of a LV device system and fails to distribute the first LV energy to the plurality of first LV devices during a second mode of operation. The system can also include a secondary power source that distributes a second LV energy to at least one second LV device of the LV device system during the first mode of operation and during the second mode of operation. The plurality of first LV devices are not critical during the second mode of operation. The at least one second LV device is critical during the second mode of operation.

### CROSS REFERENCE TO RELATED APPLICATIONS

This application claims priority under 35 U.S.C. § 119 to U.S. Provisional Patent Application Ser. No. 62/734,599, titled “Controlled Low Voltage Emergency Power Distribution” and filed on Sep. 21, 2018, the entire contents of which are hereby incorporated herein by reference.

### TECHNICAL FIELD

Embodiments described herein relate generally to emergency power distribution systems, and more particularly to systems, methods, and devices for controlled low voltage power distribution.

### BACKGROUND

A number of current electrical systems, such as lighting systems, are designed to have an emergency power supply that provides power, in the absence of a primary power source, to certain electrical devices that are deemed critical to operate during the loss of power from the primary power source. Some of these critical electrical devices operate on low voltage.

### SUMMARY

In general, in one aspect, the disclosure relates to a hybrid distributed low voltage power system. The hybrid distributed low voltage power system can include a primary power source that distributes a first low voltage (LV) energy during a first mode of operation to a plurality of first LV devices of a LV device system and fails to distribute the first LV energy to the plurality of first LV devices during a second mode of operation. The hybrid distributed low voltage power system can also include a secondary power source that distributes a second LV energy to at least one second LV device of the LV device system during the first mode of operation and during the second mode of operation. The plurality of first LV devices are not critical during the second mode of operation. The at least one second LV device can be critical during the second mode of operation.

In another aspect, the disclosure can generally relate to a hybrid distributed low voltage power system. The hybrid distributed low voltage power system can include a primary power source that distributes a low voltage (LV) energy during a first mode of operation to a plurality of LV devices and fails to distribute the LV energy to the plurality of LV devices during a second mode of operation. The hybrid distributed low voltage power system can also include a secondary power source that distributes the LV energy to at least one of the plurality of LV devices during the second mode of operation and fails to distribute the LV energy to the at least one of the plurality of LV devices during the first mode of operation. The hybrid distributed low voltage power system can further include at least one switch coupled to the primary power source and the secondary power source, where the at least one switch operates in a first position to allow the secondary power source to deliver the LV energy to the at least one of the plurality of LV devices during the second mode of operation, and where the at least one switch further operates in a second position to prevent the secondary power source from delivering the LV energy to the at least one of the plurality of LV devices during the first mode of operation.

In another aspect, the disclosure can generally relate to a low voltage power distribution module. The low voltage power distribution module can include a first input channel configured to couple to a primary power source during a first mode of operation. The low voltage power distribution module can also include a second input channel configured to couple to a secondary power source during a second mode of operation. The low voltage power distribution module can further include a first output channel configured to send a first low voltage (LV) energy, based on a first input received from the primary power source, to at least one first LV device during the first mode of operation. The low voltage power distribution module can also include a second output channel configured to send a second LV energy, based on a second input received from the secondary power source, to at least one second LV device during the second mode of operation.

These and other aspects, objects, features, and embodiments will be apparent from the following description and the appended claims.

### BRIEF DESCRIPTION OF THE DRAWINGS

The drawings illustrate only example embodiments of controlled hybrid distributed low voltage power systems and are therefore not to be considered limiting of its scope, as controlled hybrid distributed low voltage power systems may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIGS. 1A and 1B show a system diagram of a controlled hybrid distributed low voltage power system in accordance with certain example embodiments.

FIG. 2 shows a computing device in accordance with certain example embodiments.

FIG. 3 shows a system diagram of another controlled hybrid distributed low voltage power system in accordance with certain example embodiments.

FIG. 4 shows a a system diagram of yet another controlled hybrid distributed low voltage power system in accordance with certain example embodiments.

FIG. 5 shows a system diagram of still another controlled hybrid distributed low voltage power system in accordance with certain example embodiments.

### DETAILED DESCRIPTION OF EXAMPLE EMBODIMENTS

The example embodiments discussed herein are directed to systems, apparatuses, and methods of controlled hybrid distributed low voltage power systems. While example embodiments described herein are directed to use with lighting systems, example embodiments can also be used in systems having other types of devices. Examples of such other systems can include, but are not limited to, security systems, fire protection systems, emergency management systems, and assembly systems. Thus, example embodiments are not limited to use with lighting systems.

Example embodiments can be used with one or more of any number of low voltage system infrastructures. For instance, example embodiments can use Ethernet cables coupled to output channels of a power-over-Ethernet (POE) switch, where the PDM (defined below) acts as the POE switch. As another example, the PDM can serve as a gateway, where multiple devices are connected to the output channels of the PDM. In this way, the PDM can act as a point-of-load (POL) controller, described below. As yet another example, the PDM can act as a gateway, which in turn can cause the PDM to act as a POL controller. As another example, the PDM is an output device that communicates (e.g., using Ethernet) with one or more downstream POL controllers.

As used herein, the word “hybrid” means that multiple power sources (e.g., at least one primary power source and at least one secondary power source) are used to provide power to some or all of a low voltage (LV) power system (also more simply called a LV system). Also, as defined herein, the term “LV energy” can be used to provide power, control, communication, data, and/or any other type of signal that can be used by or for one or more LV devices, which are defined below.

As described herein, a user can be any person that interacts with example controlled hybrid distributed low voltage power systems. Examples of a user may include, but are not limited to, a consumer, an electrician, an engineer, a mechanic, a pipe fitter, an instrumentation and control technician, a homeowner, a floor supervisor, a consultant, a contractor, an operator, and a manufacturer's representative. For any figure shown and described herein, one or more of the components may be omitted, added, repeated, and/or substituted. Accordingly, embodiments shown in a particular figure should not be considered limited to the specific arrangements of components shown in such figure.

Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit number, and corresponding components in other figures have the identical last two digits.

In certain example embodiments, the controlled hybrid distributed low voltage power systems (or portions thereof) described herein meet one or more of a number of standards, codes, regulations, and/or other requirements established and maintained by one or more entities. Examples of such entities include, but are not limited to, Underwriters' Laboratories (UL), the Institute of Electrical and Electronics Engineers (IEEE), and the National Fire Protection Association (NFPA). For example, wiring (the wire itself and/or the installation of such wire) that electrically couples an example PDM (defined below) with a device may fall within one or more standards set forth in the National Electric Code (NEC). Specifically, the NEC defines Class 1 circuits and Class 2 circuits under various Articles, depending on the application of use.

Class 1 circuits under the NEC typically operate using line voltages (e.g., between 120 V alternating current (AC) and 600 VAC). The wiring used for Class 1 circuits under the NEC must be run in raceways, conduit, and enclosures for splices and terminations. Consequently, wiring for Class 1 circuits must be installed by a licensed electrical professional. By contrast, Class 2 circuits under the NEC typically operate at lower power levels (e.g., up to 42.2 VAC, no more than 60 V DC). The wiring used for Class 2 circuits under the NEC does not need to be run in raceways, conduit, and/or enclosures for splices and terminations. Specifically, the NEC defines a Class 2 circuit as that portion of a wiring system between the load side of a Class 2 power source and the connected equipment. Due to its power limitations, a Class 2 circuit is considered safe from a fire initiation standpoint and provides acceptable protection from electrical shock. Consequently, wiring for Class 2 circuits may not need to be installed by a licensed electrical professional.

As another example, the International Electrotechnical Commission (IEC) sets and maintains multiple standards and categorizations of electrical supply for a system. One such categorization is separated or safety extra-low voltage (SELV), which is an electrical system in which the voltage cannot exceed 25 V AC RMS (root-mean-square) (35 V AC peak) or 60 V DC under dry, normal conditions, and under single-fault conditions, including earth faults in other circuits. Another such categorization is protected extra-low voltage (PELV), which is an electrical system in which the voltage cannot exceed 25 V AC RMS (root-mean-square) (35 V AC peak) or 60 V DC under dry, normal conditions, and under single-fault conditions, except earth faults in other circuits. Yet another such categorization is functional extra-low voltage (FELV), which is an electrical system in which the voltage cannot exceed 25 V AC RMS (root-mean-square) (35 V AC peak) or 60 V DC under normal conditions. SELV, PELV, and FELV are all examples of LV systems (or LV devices of such LV systems) described herein.

Example embodiments of controlled hybrid distributed low voltage power systems will be described more fully hereinafter with reference to the accompanying drawings, in which example embodiments of controlled hybrid distributed low voltage power systems are shown. Controlled hybrid distributed low voltage power systems may, however, be embodied in many different forms and should not be construed as limited to the example embodiments set forth herein. Rather, these example embodiments are provided so that this disclosure will be thorough and complete, and will fully convey the scope of controlled hybrid distributed low voltage power systems to those of ordinary skill in the art. Like, but not necessarily the same, elements (also sometimes called components) in the various figures are denoted by like reference numerals for consistency.

Terms such as “first”, “second”, “within”, and “on” are used merely to distinguish one component (or part of a component or state of a component) from another. Such terms are not meant to denote a preference or a particular orientation. Also, the names given to various components described herein are descriptive of one or more embodiments and are not meant to be limiting in any way. Those of ordinary skill in the art will appreciate that a feature and/or component shown and/or described in one embodiment (e.g., in a figure) herein can be used in another embodiment (e.g., in any other figure) herein, even if not expressly shown and/or described in such other embodiment.

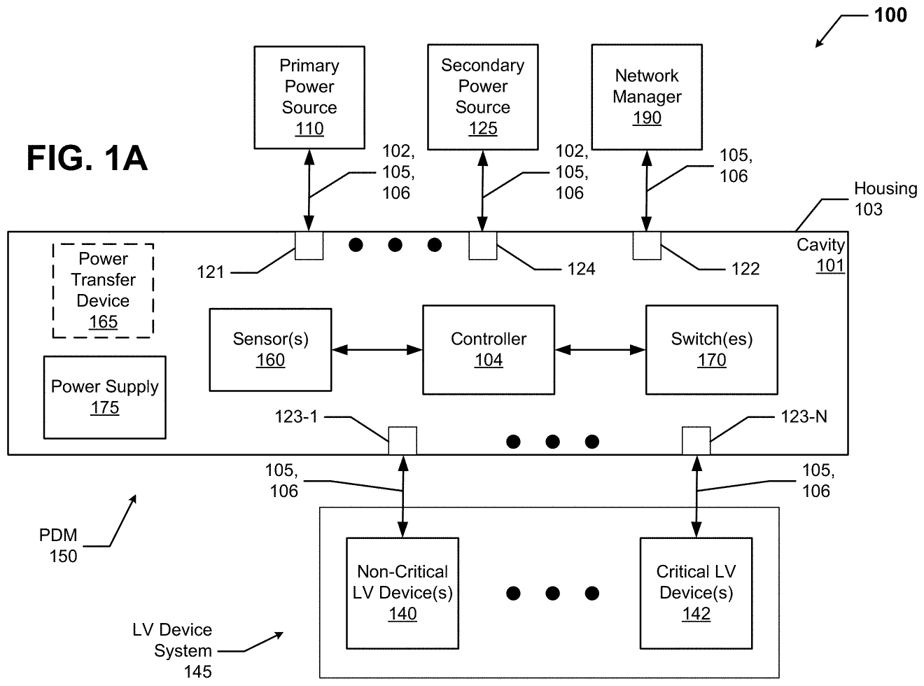

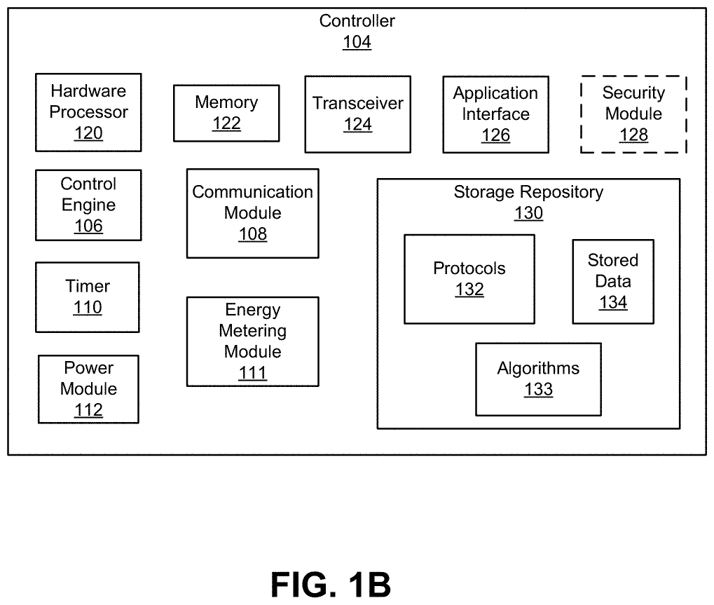

FIG. 1A shows a system diagram of a controlled hybrid distributed power system 100 in accordance with certain example embodiments. FIG. 1B shows a system diagram of a controller 104 of the controlled hybrid distributed power system 100 of FIG. 1A. The system 100 of FIG. 1A includes at least one primary power source 110, at least one power distribution module (PDM) 150, at least one secondary power source 125 (also called an emergency power source 125), at least one non-critical LV device 140, at least one critical LV device 142, and a network manager 190. The PDM 150 can include a controller 104, one or more sensors 160, one or more switches 170, a power supply 175, and an optional power transfer device 165. The non-critical LV devices 140 and the critical LV devices 142 make up a LV device system 145.

A non-critical LV device 140 and a critical LV device 142 are essentially the same thing, except that that the critical LV device 142 operates at all times (e.g., during a power outage) while the non-critical LV device 140 only operates during normal operating conditions (e.g., when there is no power outage). A non-critical LV device 140 can also be called a non-critical LV electrical device 140, and a critical LV device 142 can also be called a critical LV electrical device 142 herein. In some cases, a non-critical LV device 140 and/or a critical LV device 142 can include its own local controller, which can have some or all of the components of the controller 104 of the PDM 150, as described below. In such a case, the local controller can be used to control one or more non-critical LV devices 140 and/or one or more critical LV devices 142.

A non-critical LV device 140 and a critical LV device 142 can be any electrical device that operates on low voltage or in a Class 2 circuit. An example of a non-critical LV device 140 and a critical LV device 142 is a light fixture. In such a case, examples of a light fixture can include, but are not limited to, a troffer light, a can light, an emergency egress light, a floodlight, a spot light, and a pendant light. Other examples of a non-critical LV device 140 and a critical LV device 142 can include, but are not limited to, a sensing device (e.g., motion sensor, a temperature sensor, a smoke alarm), an inverter, a camera, a wall outlet, a photocell/timer, a power source (e.g., a LED driver, a ballast, a buck converter, a buck-boost converter), a controller (e.g., a pulse width modulator, a pulse amplitude modulator, a constant current reduction dimmer), a keypad, a touchscreen, a dimming switch, a thermostat, a shade controller, a universal serial bus charger, a meter (e.g., water meter, gas meter, electric meter), and an illuminated exit sign.

The LV device system 145 includes one or more non-critical LV devices 140 and one or more critical LV devices 142. The devices (e.g., non-critical LV devices 140, critical LV devices 142) included within the LV device system 145 can share a common purpose (e.g., provide general illumination), a common location (e.g., a room, a floor, a building), a common controller (e.g., the network manager 190), and/or have some other commonality. The one or more non-critical LV devices 140 can be coupled to one or more output channels 123 (e.g., output channel 123-1) of the PDM 150. When multiple non-critical LV devices 140 are coupled to a single output channel 123 of the PDM 150, those non-critical LV devices 140 can be connected in series and/or in parallel with respect to each other. Similarly, one or more critical LV devices 142 can be coupled to one or more other output channels 123 (e.g., output channel 123-N) of the PDM 150 that are distinct from the one or more output channels 123 connected to the non-critical LV devices 140. When multiple critical LV devices 142 are coupled to a single output channel 123 of the PDM 150, those critical LV devices 142 can be connected in series and/or in parallel with respect to each other.

In some cases, one or more non-critical LV devices 140 and/or one or more critical LV devices 142 can have or include a point-of-load (POL) controller (also called, for example, a driver or a ballast). In such a case, the POL controller is usually located within a housing of the LV device (although a POL controller can also be located remotely from the LV device that it controls) and is designed to receive a LV signal. When a LV signal is received by the POL controller, the POL controller provides power regulation and/or control to the LV device. In other words, a POL controller can perform one or more of a number of functions. Such functions can include, but are not limited to, receiving instructions (as from the PDM 150), collecting and recording operational data, recording communications with the PDM 150 and/or other devices, and sending operational data to the PDM 150 and/or other devices.

The POL controller can also recognize addresses in a LV signal received from the PDM 150. In this way, if a LV signal is broadcast to multiple non-critical LV devices 140 and/or critical LV devices 142, the POL controller of a particular LV device can determine whether the LV signal should be ignored (e.g., in the case where the LV signal is not addressed to that particular LV device) or read and subsequently followed.

Each of the components of the system 100 are electrically coupled to at least one other component of the system 100 using wired and/or wireless technology. For example, the primary power source 110 and the secondary power source 125 are coupled to the PDM 150 using one or more line voltage cables 102. As another example, the PDM 150 is coupled to the non-critical LV devices 140 and the critical LV devices 142 using one or more LV cables 105. As yet another example, the PDM 150 can be coupled to the network manager 190 using one or more communication links 106. Each of these technologies will be discussed below in more detail.

The network manager 190 is a device or component that controls all or a portion (e.g., the controller 104 of the PDM 150, the primary power source 110, the secondary power source 125) of the system 100. The network manager 190 can be called by any of a number of other names, including but not limited to master controller, system manager, and system controller. As shown in FIG. 1A, the network manager 190 of FIG. 1A is coupled to one of a number of input channels 122 of the PDM 150 using one or more LV cables 105 and/or one or more communication links 106. The network manager 190 is a device or component that can communicate with the PDM 150. The network manager 190 can also communicate, directly or indirectly, with one or more primary power sources 110, one or more secondary power sources 125, one or more non-critical LV devices 140, and/or one or more critical LV devices 142.

For example, the network manager 190 can send instructions to the controller 104 of the PDM 150 as to when certain switches 170 should be operated (change state). As another example, the network manager 190 can receive data (e.g., run time, current flow) associated with the operation of each primary power source 140 and/or each secondary power source 125 to determine when maintenance should be performed on the primary power source 110 or the secondary power source 125 (or portions thereof).

The network manager 190 can be substantially similar (e.g., in terms of functionality, in terms of components) to the controller 104. Alternatively, the network manager 190 can include one or more of a number of features in addition to, or altered from, the features of the controller 104 described below. In some cases, the network manager 190 can be any LV device (e.g., a critical LV device 142) that controls one or more of the other non-critical LV devices 140 and/or critical LV devices 142 in the system 100. In such a case, examples of a network manager 190 can include, but are not limited to, a thermostat, a dimmer switch, a control switch, a control panel, and a power switch.

The network manager 190 of FIG. 1A can communicate with (e.g., send instructions to, receive data from) the PDM 150 and/or a power source (e.g., secondary power source 125). Instructions sent by the network manager 190 to the PDM 150 can affect the operation of some or all of the non-critical LV devices 140 coupled to one or more particular output channels 123 of the PDM 150, some or all of the critical LV devices 142 coupled to one or more particular output channels 123 of the PDM 150, or any combination thereof. Communication between the PDM 150, the network manager 190, the non-critical LV devices 140, the critical LV devices 142, the primary power sources 110, and the secondary power sources 125 in the system 100 can include the transfer (sending and/or receiving) of power, control, and/or data using the LV cables 105 and/or the communication links 106, using wired and/or wireless technology.

Such control and data can include instructions, status reports, notifications, and/or any other type of information. Specific examples of the power, data, and/or control sent between the PDM 150, the network manager 190, the non-critical LV devices 140, the critical LV devices 142, the primary power sources 110, and the secondary power sources 125 can include, but are not limited to, delivery of power signals (e.g., LV signals), a light level, a light fade rate, a demand response, occupancy of an area, detection of daylight, a security override, a temperature, a measurement of power, a measurement or calculation of power factor, operational status, a mode of operation, a dimming curve, a color and/or correlated color temperature (CCT), a manual action, manufacturing information, performance information, warranty information, air quality measurements, upgrade of firmware, update of software, position of a shade, and a device identifier.

Each primary power source 110 generates and/or delivers, directly or indirectly, electrical power that is used by the various non-critical LV devices 140 and, in some cases, the critical LV devices 142 in the system 100. Each primary power source 110 of FIG. 1A is coupled to one of a number of input channels 121 of the PDM 150 using one or more line voltage cables 102, one or more LV cables 105, and/or one or more communication links 106. The power generated or delivered by the primary power source 110 can be called LV energy or some other form of power that is converted into LV energy by the optional power transfer device 165 of the PDM 150.

A primary power source 110 can generate, directly or indirectly, power in the form of alternating current (AC) or direct current (DC) power. A primary power source 110 can also generate power at any of a number of appropriate amounts. Examples of voltages generated by a primary power source 110 can include 120 VAC, 240 VAC, 277 VAC, 24 VDC, 48 VDC, 380 VDC, and 480 VAC. If the LV energy (also sometimes called LV power herein) that is directly output by a primary power source 110 or output by a power transfer device 165 of the PDM 150 is AC power, the frequency can be 50 Hz, 60 Hz, or some other frequency. Examples of a primary power source 110 (or portion thereof) can include, but are not limited to, AC mains, a battery, a photovoltaic (PV) solar panel, a wind turbine, a power capacitor, an energy storage device, a power transformer, a fuel cell, a generator, and a circuit panel.

The power generated by the primary power source 110 is sent to the PDM 150 using one or more line voltage cables 102 (e.g., in the event that the PDM 150 includes an optional power transfer device 165) or using one or more LV cables 105 (e.g., in the event that the PDM 150 does not include the optional power transfer device 165). In some cases, the primary power source 110 can include a power transfer device. In such a case, the power transfer device can convert power received by the primary power source 110 into LV energy or some other form of power that can be converted by the optional power transfer device 165 of the PDM 150 into LV energy. A power transfer device can be or include one or more of any number of components that convert power received or generated by the primary power source 110 into LV energy. Examples of such components can include, but are not limited to, a transformer, an inverter, a converter, an inductor, and a diode bridge.

The line voltage cables 102 can include one or more conductors made of one or more electrically conductive materials (e.g., copper, aluminum). The size (e.g., gauge) of the line voltage cables 102 (and/or conductors therein) are sufficient to carry the line voltage power of the primary power source 110. Each line voltage cable 102 may be coated with an insulator made of any suitable electrically non-conductive material (e.g., rubber, plastic) to keep the electrical conductors electrically isolated from any other conductor in the line voltage cable 102.

The one or more LV cables 105 are used to electrically couple, directly or indirectly, one or more of the non-critical LV devices 140 and one or more of the critical LV devices 142 to the PDM 150. Also, as discussed above, if the PDM 150 has no power transfer device 165, then one or more LV cables 104 can be used to connect the PDM 150 to the primary power source 110 and the secondary power source 125. The LV cables 105 can have one or more pairs of conductors. Each pair of conductors of a LV cable 105 can deliver LV signals that represent power signals, control signals, data signals, and/or communication signals.

In some cases, a LV cable 105 has at least one pair of conductors that carries power signals and at least one pair of conductors that carries other (e.g., control) signals. The LV cables 105 can be plenum rated. For example, one or more of the LV cables 105 can be used in drop ceilings without conduit or cable trays. A communication link 106 can be LV cable 105 (meaning that the LV cable 105 transfers both power and communication signals, as with POE applications), Ethernet cable, a RS485 cable, and/or some other wired technology. In addition, or in the alternative, the communication link 106 can be part of a network using wireless technology (e.g., Wi-Fi, Bluetooth, Bluetooth Low Energy, Zigbee, 6LoPan). If a LV cable 105 is an Ethernet cable, then the LV cable 105 can comply with the Category 5 (CAT5) or the Category 6 (CAT6) standard.

Each secondary power source 125 generates and/or delivers, directly or indirectly, electrical power that is used by the various critical LV devices 142 in the system 100. Each secondary power source 125 of FIG. 1A is electrically coupled to the PDM 150. Specifically, each secondary power source 125 of FIG. 1A is coupled to one of a number of input channels 124 of the PDM 150 using one or more line voltage cables 102, one or more LV cables 105, and/or one or more communication links 106. Any power delivered by a secondary power source 125 can be called reserve power, which is or is converted to a type of LV energy.

In certain example embodiments, the secondary power source 125 provides LV energy when the primary power source 110 is unable to provide its own LV energy. In some cases, a secondary power source 125 can include an energy storage device. For example, when the primary power source 110 stops delivering primary power, as during a power outage), the secondary power source 125 can then release (or continue to release) its LV energy to the PDM 150. In this way, the secondary power source 125 can provide LV energy to the PDM 150 in lieu of the LV energy provided by the primary power source 110A.

If the secondary power source 125 includes an energy storage device, the energy storage device can use one or more of any type of storage technology, including but not limited to a battery, a flywheel, an ultracapacitor, and a supercapacitor. If the energy storage device includes a battery, the battery technology can vary, including but not limited to lithium ion, lead/acid, solid state, graphite anode, titanium dioxide, nickel cadmium, nickel metal hydride, nickel iron, and lithium polymer.

In some cases, the secondary power source 125 can include a power transfer device. In such a case, the power transfer device can convert power received or generated by the secondary power source 125 into LV energy or some other form of power that can be converted by the optional power transfer device 165 of the PDM 150 into LV energy. A power transfer device can be or include one or more of any number of components that convert power received by the secondary power source 125 into LV energy. Examples of such components can include, but are not limited to, a transformer, an inverter, a converter, an inductor, and a diode bridge.

In cases where at least one of the non-critical LV devices 140 or the critical LV devices 142 in the system 100 uses an amount and/or type (e.g., DC, AC) of LV energy that is different from the amount and type of power delivered by the primary power source 110 or the secondary power source 125, respectively, the power transfer device 165 of the PDM 150 is used to create the appropriate type and level of LV energy for each such non-critical LV device 140 and/or each such critical LV device 142. In this way, the power transfer device 165 of the PDM 150 can convert the power that the PDM 150 receives from the primary power source 110 or the secondary power source 125 to LV power, where the LV power can be used by the various downstream non-critical LV devices 140 and/or critical LV devices 142. In some cases, one or more of the non-critical LV devices 140 and/or the critical LV devices 142 can include a power transfer device to generate LV energy needed to operate that particular non-critical LV device 140 and/or critical LV device 142. As defined herein, LV power has a voltage that does not exceed approximately 42.4 VAC (root mean square) or 60 VDC.

In the system 100 shown in FIG. 1A, the portions of the system 100 that involve the LV energy (e.g., the non-critical LV devices 140 and/or the critical LV devices 142 of each output channel 123 of the PDM 150) are classified as a “safe” system under currently-existing standards and/or regulations. For example, the LV energy portions of the system 100 can be considered a NEC Class 2 system. As another example, the LV energy portions of the system 100 can be considered free from risk of fire and/or electrical shock.

As discussed above, the PDM 150 can include a controller 104, one or more switches 170, one or more sensors 160, and an optional power transfer device 165. The PDM 150 can also have a number of channels disposed in or on the housing 103 of the PDM 150. For example, the PDM 150 can have one or more input channels 121 that are coupled to one or more primary power sources 110. As another example, the PDM 150 can have one or more input channels 124 that are coupled to one or more secondary power sources 125. As yet another example, the PDM 150 can have one or more input channels 122 that are coupled to the network manager 190. As still another example, the PDM 150 can have one or more output channels 123 that are coupled to one or more non-critical LV devices 140 and one or more critical LV devices 142. Each of these channels of the PDM 150 can be configured to receive a line voltage cable 102, a LV cable 105, and/or a communication link 106.

In some cases, a component (e.g., the controller 104, the power transfer device 165) of the PDM 150 is coupled to one or more non-critical LV devices 140 and one or more critical LV devices 142 using wireless technology (e.g., inductive power transfer, wireless communication). In such a case, one or more of the output channels 123 of the PDM 150 can be virtual rather than physical connectors. Similarly, one or more of the input channels of the PDM 150 can be virtual rather than physical connectors.

The optional power transfer device 165 of the PDM 150 is used receive power of an amount (e.g., 120 V) and type (e.g., AC) and manipulate that power so that the power transfer device 165 sends power of a different amount (e.g., 12V) and/or type (e.g., DC). A power transfer device 165, when present, is electrically located between one or more input channels (e.g., input channel 121, input channel 124) and one more output channels 123. The PDM 150 can have one or multiple power transfer devices 165. Examples of a power transfer device 165 can include, but are not limited to, a transformer, a converter, a diode bridge, and an inverter. A power transfer device 165 can also include one or more of a number of components, including but not limited to an inductor, a capacitor, a resistor, and a diode.

The one or more sensors 160 of the PDM 150 can be any type of sensing device that measure one or more parameters. Examples of types of sensors 160 can include, but are not limited to, a resistor, a Hall Effect current sensor, a thermistor, a vibration sensor, an accelerometer, a passive infrared sensor, a photocell, and a resistance temperature detector. A parameter that can be measured by a sensor 160 can include, but is not limited to, current, voltage, power, resistance, ambient light, sound, movement, vibration, position, and temperature. Examples of a sensor 160 can include, but are not limited to, a volt meter, an ammeter, a resistor, a photocell, a motion detector, an audio detector, a pressure detector, a temperature sensor, and an air flow sensor. A sensor 160 can be located within the housing 103 of the PDM 150, disposed on the housing 103 of the PDM 150, or located outside the housing 103 of the PDM 150.

A switch 170 can determine which primary power sources 140 and which secondary power sources 142 are coupled to which particular non-critical LV devices 140 and which critical LV devices 142 at any particular point in time. In some cases, as with a 2-pole switch, a switch 170 has an open state and a closed state. In the open state, the switch 170 creates an open circuit, which prevents LV energy from being delivered to one or more particular non-critical LV devices 140 and/or one or more particular critical LV devices 142. In the closed state, the switch 170 creates a closed circuit, which allows LV energy to be delivered to one or more particular non-critical LV devices 140 and/or one or more particular critical LV devices 142. In other cases, a switch 170 can have 3 or more poles, where each pole is coupled to a different source of power (or group of sources of power) and/or a different LV device (or group of LV devices).

One or more switches 170 can also be used to determine which particular primary power source 140 or secondary power source 142 provides power to one or more components (e.g., the power supply 175, the power transfer device 165) of the PDM 150. For example, a switch 170 (as controlled, for example, by the controller 104) can be configured to allow power from a primary power source 140 to provide power to the power supply 175 when there is no power outage. When a power outage occurs, the switch 170 can be reconfigured to allow power from a secondary power source 142 to provide power to the power supply 175 for the duration of the power outage. When the power outage ends, then the switch 170 can revert to its original configuration to allow power from a primary power source 140 to provide power to the power supply 175.

In certain example embodiments, the position of each switch is controlled by the control engine 106 of the controller 104. Each switch 170 can be any type of device that changes state or position (e.g., opens, closes) based on certain conditions. Examples of a switch can include, but are not limited to, a transistor, a dipole switch, a relay contact, a resistor, and a NOR gate. In certain example embodiments, each switch 170 can operate (e.g., change from a closed position to an open position, change from an open position to a closed position) based on input from the controller 104.

The power supply 175 of the PDM 150 provides power to one or more of the other components of the PDM 150. The power supply 175 can be substantially the same as, or different than, the power module 112 of the controller 104, as described below. The power supply 175 can include one or more of a number of single or multiple discrete components (e.g., transistor, diode, resistor), and/or a microprocessor. The power supply 175 may include a printed circuit board, upon which the microprocessor and/or one or more discrete components are positioned, and/or a dimmer.

A power supply 175 can include one or more components (e.g., a transformer, a diode bridge, an inverter, a converter) that receives power (for example, through an electrical cable) from a primary power source 110 and/or a secondary power source 125. Upon receiving this power, the power supply 175 generates power of a type (e.g., AC, DC) and level (e.g., 12V, 24V, 120V) that can be used by one or more of the other components (e.g., the controller 104, a sensor 160, a switch 170, the power transfer device 165) of the PDM 150. In addition, or in the alternative, the power supply 175 can be a source of power in itself. For example, a power supply 1750 can be or include a battery, a localized photovoltaic power system, or some other source of independent power.

The PDM 150 can be placed in any of a number of environments. In such a case, the housing 103 of the PDM 150 can be configured to comply with applicable standards for any of a number of environments. For example, the PDM 150 can be rated as a Division 1 or a Division 2 enclosure under NEC standards. Similarly, any of the sensors 160 or other devices (e.g., critical LV devices 142, secondary power source 125) communicably coupled to the PDM 150 can be configured to comply with applicable standards for any of a number of environments. For example, a sensor 160 can be rated as a Division 1 or a Division 2 enclosure under NEC standards.

The housing 103 of the PDM 150 can be used to house one or more components of the PDM 150, including one or more components of the controller 104. For example, as shown in FIGS. 1A and 1B, the controller 104 (which in this case includes the control engine 106, the communication module 108, the timer 110, the energy metering module 111, the power module 112, the storage repository 130, the hardware processor 120, the memory 122, the transceiver 124, the application interface 126, and the optional security module 128), the power supply 175, the sensors 160, the switches 170, and the optional power transfer device 165 are disposed in the cavity 101 formed by the housing 103. In alternative embodiments, any one or more of these or other components of the PDM 150 can be disposed on the housing 103 and/or remotely from the housing 103.

The storage repository 130 can be a persistent storage device (or set of devices) that stores software and data used to assist the controller 104 in communicating with the network manager 190, the one or more primary power sources 110, the one or more secondary power sources 125, the non-critical LV devices 140, and the critical LV devices 142 within the system 100. In one or more example embodiments, the storage repository 130 stores one or more protocols 132, algorithms 133, and stored data 134. The protocols 132 can include any processes or logic steps that are implemented by the control engine 106 based on certain conditions at a point in time.

The protocols 132 can include any of a number of communication protocols that are used to send and/or receive data between the controller 104, the network manager 190, the primary power source 110, the secondary power source 125, the non-critical LV devices 140, and the critical LV devices 142. One or more of the protocols 132 can be a time-synchronized protocol for communication. Examples of such time-synchronized protocols can include, but are not limited to, a highway addressable remote transducer (HART) protocol, a wirelessHART protocol, and an International Society of Automation (ISA) 100 protocol.

The algorithms 133 can be any models, formulas, and/or other similar operational implementations that the control engine 106 of the controller 104 uses. One or more algorithms 133 can at times be used in conjunction with one or more protocols 132. An example of a protocol 132 and an algorithm 133 working in conjunction with each other follows. An algorithm 133 can determine whether an amount of power, as measured by a sensor 160, delivered by a primary power source 110 to the PDM 150 falls below a threshold value. If the result of the algorithm 133 determines that the measured value of power does fall below the threshold value (indicating, for example, that there is a power outage), a protocol 132 can be followed by the control engine 106 to operate one or more switches 170 in a certain manner so that, while the measured value of power continues to fall below the threshold value, the secondary power source 125 provides LV energy to the critical LV devices 142 and so that the non-critical LV devices 140 do not receive power.

Another example of a protocol 132 and an algorithm 133 working in conjunction with each other follows. An algorithm 133 can determine whether an amount of power, as measured by a sensor 160, delivered by a primary power source 110 to the PDM 150 is above a threshold value. If the algorithm 133 determines that the measured value of power is above the threshold value (indicating, for example, that there is no power outage), a protocol 132 can be followed by the control engine 106 to operate one or more switches 170 in a certain manner so that the primary power source 110 provides LV energy to all of the non-critical LV devices 140 and all of the critical LV devices 142.

Stored data 134 can be any data associated with the system 100 (including the PDM 150, the primary power source 110, the secondary power source 125, the non-critical LV devices 140, the critical LV devices 142, and/or any components thereof), any measurements taken by the sensors 160, measurements taken by the energy metering module 111, time measured by the timer 110, threshold values, results of previously run or calculated algorithms, updates to the protocols 132, user preferences, and/or any other suitable data. Such data can be any type of data, including but not limited to historical data, current data, and forecast data. The stored data 134 can be associated with some measurement of time derived, for example, from the timer 110.

Examples of a storage repository 130 can include, but are not limited to, a database (or a number of databases), a file system, a hard drive, flash memory, cloud-based storage, some other form of solid state data storage, or any suitable combination thereof. The storage repository 130 can be located on multiple physical machines, each storing all or a portion of the protocols 132, the algorithms 133, and/or the stored data 134 according to some example embodiments. Each storage unit or device can be physically located in the same or in a different geographic location.

The storage repository 130 can be operatively connected to the control engine 106. In one or more example embodiments, the control engine 106 includes functionality to communicate with other components (e.g., a sensor 160) of the PDM 150, the network manager 190, the primary power source 110, the secondary power source 125, the non-critical LV devices 140, and the critical LV devices 142 in the system 100. More specifically, the control engine 106 sends information to and/or receives information from the storage repository 130 in order to communicate with other components (e.g., a sensor 160) of the PDM 150, the network manager 190, the primary power source 110, the secondary power source 125, the non-critical LV devices 140, and the critical LV devices 142. As discussed below, the storage repository 130 can also be operatively connected to the communication module 108 in certain example embodiments.

In certain example embodiments, the control engine 106 of the controller 104 controls the operation of one or more components (e.g., the communication module 108, the timer 110, the transceiver 124) of the controller 104. For example, the control engine 106 can activate the communication module 108 when the communication module 108 is in “sleep” mode and when the communication module 108 is needed to send data received from another component (e.g., a sensor 160) in the system 100. As another example, the control engine 106 can acquire the current time using the timer 110. The timer 110 can enable the controller 104 to control the PDM 150 (including any components thereof, such as one or more switches 170) even when the controller 104 has no communication with the network manager 190.

As yet another example, the control engine 106 can direct the energy metering module 111 to measure and send power consumption information of the power supply 175 to the network manager 190. In some cases, the control engine 106 of the controller 104 can control the position (e.g., open, closed) of each switch 170, which causes a particular primary power source 110 and/or a particular secondary power source 125 to provide LV energy to any of a number of particular non-critical LV devices 140 and/or any of a number of particular critical LV devices 142.

For example, the control engine 106, following a protocol 132, can instruct a sensor 160 to measure an amount of power received from a primary power source 110. The control engine 106 can then use an algorithm 133 to determine whether the amount of power received by the PDM 150 from the primary power source 110 falls below a threshold value. If so, indicating, for example, that there is a power outage, then the control engine 106 can follow another protocol 132 to operate one or more switches 170 so that the secondary power source 125 provides LV energy to the critical LV devices 142.

As another example, the control engine 106, following a protocol 132, can instruct a sensor 160 to measure an amount of power received from a primary power source 110. The control engine 106 can then use an algorithm 133 to determine whether the amount of power received by the PDM 150 from the primary power source 110 exceeds a threshold value. If so, indicating, for example, that there is no power outage, then the control engine 106 can follow another protocol 132 to operate one or more switches 170 so that the primary power source 110 provides LV energy to all of the non-critical LV devices 140 and all of the critical LV devices 142.

In certain example embodiments, the control engine 106 can include an interface that enables the control engine 106 to communicate with one or more components (e.g., a power supply 175, a switch 170) of the PDM 150. For example, if a power supply 175 of the PDM 150 operates under IEC Standard 62386, then the power supply 175 can have a serial communication interface that will transfer data (e.g., stored data 134) measured by the sensors 160. In such a case, the control engine 106 can also include a serial interface to enable communication with the power supply 175 within the PDM 150. Such an interface can operate in conjunction with, or independently of, the protocols 132 used to communicate between the controller 104 and the network manager 190, the primary power source 110, the secondary power source 125, the non-critical LV devices 140, and the critical LV devices 142.

The control engine 106 (or other components of the controller 104) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

The communication module 108 of the controller 104 determines and implements a communication protocol (e.g., from the protocols 132 of the storage repository 130) that is used when the control engine 106 communicates with (e.g., sends signals to, receives signals from) the network manager 190, the primary power source 110, the secondary power source 125, the non-critical LV devices 140, and the critical LV devices 142. In some cases, the communication module 108 accesses the stored data 134 to determine which protocol 132 is used to communicate with the sensor 160 (or other component of the system 100) associated with certain stored data 134. In addition, the communication module 108 can interpret the protocol 132 of a communication received by the controller 104 so that the control engine 106 can interpret the communication.

The communication module 108 can send and receive data between the controller 104, other components of the PDM 150, the network manager 190, the primary power source 110, the secondary power source 125, the non-critical LV devices 140, and the critical LV devices 142. The communication module 108 can send and/or receive data in a given format that follows a particular protocol 132. The control engine 106 can interpret the data packet received from the communication module 108 using the protocol 132 information stored in the storage repository 130. The control engine 106 can also facilitate the data transfer between one or more sensors 160, the network manager 190, the primary power source 110, the secondary power source 125, the non-critical LV devices 140, and the critical LV devices 142 by converting the data into a format understood by the communication module 108.

The communication module 108 can send data (e.g., protocols 132, algorithms 133, stored data 134, operational information, alarms) directly to and/or retrieve data directly from the storage repository 130. Alternatively, the control engine 106 can facilitate the transfer of data between the communication module 108 and the storage repository 130. The communication module 108 can also provide encryption to data that is sent by the controller 104 and decryption to data that is received by the controller 104. The communication module 108 can also provide one or more of a number of other services with respect to data sent from and received by the controller 104. Such services can include, but are not limited to, data packet routing information and procedures to follow in the event of data interruption.

The timer 110 of the controller 104 can track clock time, intervals of time, an amount of time, and/or any other measure of time. The timer 110 can also count the number of occurrences of an event, whether with or without respect to time. Alternatively, the control engine 106 can perform the counting function. The timer 110 is able to track multiple time measurements concurrently. The timer 110 can track time periods based on an instruction received from the control engine 106, based on an instruction programmed in the software for the controller 104, based on some other condition or from some other component, or from any combination thereof.

The timer 110 can be configured to track time when there is no power delivered to the controller 104 (e.g., the power module 112 malfunctions) using, for example, a super capacitor or a battery backup. In such a case, when there is a resumption of power delivery to the controller 104, the timer 110 can communicate any aspect of time to the controller 104. In such a case, the timer 110 can include one or more of a number of components (e.g., a super capacitor, an integrated circuit (IC)) to perform these functions.

The energy metering module 111 of the controller 104 measures one or more components of power (e.g., current, voltage, resistance, VARs, watts) at one or more points (e.g., output of each power supply 175) associated with the PDM 150. The energy metering module 111 can include any of a number of measuring devices and related devices, including but not limited to a voltmeter, an ammeter, a power meter, an ohmmeter, a current transformer, a potential transformer, and electrical wiring. The energy metering module 111 can measure a component of power continuously, periodically, based on the occurrence of an event, based on a command received from the control module 106, and/or based on some other factor. In some cases, the energy metering module 111 can be a type of sensor 160.

The power module 112 of the controller 104 provides power to one or more other components (e.g., timer 110, control engine 106) of the controller 104. In addition, in certain example embodiments, the power module 112 can provide power to the power supply 175 and/or other components of the PDM 150. The power module 112 can include one or more of a number of single or multiple discrete components (e.g., transistor, diode, resistor), and/or a microprocessor. The power module 112 may include a printed circuit board, upon which the microprocessor and/or one or more discrete components are positioned. In some cases, the power module 112 can include one or more components that allow the power module 112 to measure one or more elements of power (e.g., voltage, current) that is delivered to and/or sent from the power module 112. Alternatively, the energy metering module 111 can measure one or more elements of power that flows into, out of, and/or within the controller 104.

The power module 112 can include one or more components (e.g., a transformer, a diode bridge, an inverter, a converter) that receives power (for example, through an electrical cable) from a source (e.g., the power supply 175, a primary power source 110) and generates power of a type (e.g., AC, DC) and level (e.g., 12V, 24V, 120V) that can be used by the other components of the controller 104. The power module 112 can use a closed control loop to maintain a preconfigured voltage or current with a tight tolerance at the output. The power module 112 can also protect the rest of the electronics (e.g., hardware processor 120, transceiver 124) in the PDM 150 from surges generated in the line. In addition, or in the alternative, the power module 112 can be or include a source of power in itself to provide signals to the other components of the controller 104 and/or the power supply 175. For example, the power module 112 can be or include a battery. As another example, the power module 112 can be or include a localized photovoltaic power system.

In certain example embodiments, the power module 112 of the controller 104 can also provide power and/or control signals, directly or indirectly, to one or more of the sensors 160. In such a case, the control engine 106 can direct the power generated by the power module 112 to the sensors 160. In this way, power can be conserved by sending power to the sensors 160 of the PDM 150 when those devices need power, as determined by the control engine 106.

The hardware processor 120 of the controller 104 executes software, algorithms, and firmware in accordance with one or more example embodiments. Specifically, the hardware processor 120 can execute software on the control engine 106 or any other portion of the controller 104, as well as software used by other components of the PDM 150, the network manager 190, the primary power source 110, the secondary power source 125, the non-critical LV devices 140, and the critical LV devices 142. The hardware processor 120 can be an IC, a central processing unit, a multi-core processing chip, SoC, a multi-chip module including multiple multi-core processing chips, or other hardware processor in one or more example embodiments. The hardware processor 120 is known by other names, including but not limited to a computer processor, a microprocessor, and a multi-core processor.

In one or more example embodiments, the hardware processor 120 executes software instructions stored in memory 122. The memory 122 includes one or more cache memories, main memory, and/or any other suitable type of memory. The memory 122 can include volatile and/or non-volatile memory. The memory 122 is discretely located within the controller 104 relative to the hardware processor 120 according to some example embodiments. In certain configurations, the memory 122 can be integrated with the hardware processor 120.

In certain example embodiments, the controller 104 does not include a hardware processor 120. In such a case, the controller 104 can include, as an example, one or more field programmable gate arrays (FPGA), one or more insulated-gate bipolar transistors (IGBTs), and/or one or more ICs. Using FPGAs, IGBTs, ICs, and/or other similar devices known in the art allows the controller 104 (or portions thereof) to be programmable and function according to certain logic rules and thresholds without the use of a hardware processor. Alternatively, FPGAs, IGBTs, ICs, and/or similar devices can be used in conjunction with one or more hardware processors 120.

The transceiver 124 of the controller 104 can send and/or receive control and/or communication signals. Specifically, the transceiver 124 can be used to transfer data between the controller 104 and the primary power source 110, the secondary power source 125, the network manager 190, the non-critical LV devices 140, the critical LV devices 142, and/or the sensors 160. The transceiver 124 can use wired and/or wireless technology. The transceiver 124 can be configured in such a way that the control and/or communication signals sent and/or received by the transceiver 124 can be received and/or sent by another transceiver that is part of another component of the PDM 150, the network manager 190, the primary power source 110, the secondary power source 125, the non-critical LV devices 140, and the critical LV devices 142. The transceiver 124 can use any of a number of signal types, including but not limited to radio signals.

When the transceiver 124 uses wireless technology, any type of wireless technology can be used by the transceiver 124 in sending and receiving signals. Such wireless technology can include, but is not limited to, Wi-Fi, visible light communication, cellular networking, and Bluetooth. The transceiver 124 can use one or more of any number of suitable communication protocols (e.g., ISA100, HART) when sending and/or receiving signals. Such communication protocols can be stored in the communication protocols 132 of the storage repository 130. Further, any transceiver information for another component of the PDM 150, the network manager 190, the primary power source 110, the secondary power source 125, the non-critical LV devices 140, and the critical LV devices 142 can be part of the stored data 134 (or similar areas) of the storage repository 130.

In some cases, the controller 104 can have multiple transceivers 124. In such a case, each transceiver 124 can communicate with one or more LV devices (e.g., non-critical LV devices 140, critical LV devices 142) through one or more output channels 123 of the PDM 150. For example, a controller 104 can have eight transceivers 124, one for each of eight output channels 123 of the PDM 150.

Optionally, in one or more example embodiments, the security module 128 secures interactions between the controller 104, other components of the PDM 150, the network manager 190, the primary power source 110, the secondary power source 125, the non-critical LV devices 140, and/or the critical LV devices 142. More specifically, the security module 128 authenticates communication from software based on security keys verifying the identity of the source of the communication. For example, user software may be associated with a security key enabling the software of the network manager 190 to interact with the controller 104 and/or the sensors 160. Further, the security module 128 can restrict receipt of information, requests for information, and/or access to information in some example embodiments. The security module 128 can also validate a communication or signal received from another component (e.g., a non-critical LV device 140).

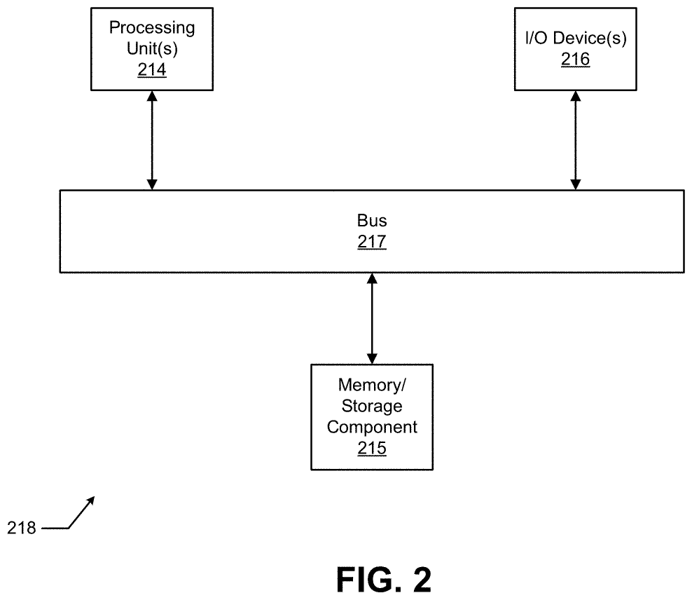

FIG. 2 illustrates one embodiment of a computing device 218 that implements one or more of the various techniques described herein, and which is representative, in whole or in part, of the elements described herein pursuant to certain exemplary embodiments. For example, the controller 104 (including components such as the control engine 106, the transceiver 124, the hardware processor 120) of FIGS. 1A and 1B can be considered a computing device 218. Computing device 218 is one example of a computing device and is not intended to suggest any limitation as to scope of use or functionality of the computing device and/or its possible architectures. Neither should computing device 218 be interpreted as having any dependency or requirement relating to any one or combination of components illustrated in the example computing device 218.

Computing device 218 includes one or more processors or processing units 214, one or more memory/storage components 215, one or more input/output (I/O) devices 216, and a bus 217 that allows the various components and devices to communicate with one another. Bus 217 represents one or more of any of several types of bus structures, including a memory bus or memory controller, a peripheral bus, an accelerated graphics port, and a processor or local bus using any of a variety of bus architectures. Bus 217 includes wired and/or wireless networks.

Memory/storage component 215 represents one or more computer storage media. Memory/storage component 215 includes volatile media (such as random access memory (RAM)) and/or nonvolatile media (such as read only memory (ROM), flash memory, optical disks, magnetic disks, and so forth). Memory/storage component 215 includes fixed media (e.g., RAM, ROM, a fixed hard drive, etc.) as well as removable media (e.g., a Flash memory drive, a removable hard drive, an optical disk, and so forth).

One or more I/O devices 216 allow a customer, utility, or other user to enter commands and information to computing device 218, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 218 is connected to a network (not shown) (e.g., a local area network (LAN), a wide area network (WAN) such as the Internet, cloud, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 218 includes at least the minimal processing, input, and/or output means necessary to practice one or more embodiments.

Further, those skilled in the art will appreciate that one or more elements of the aforementioned computer device 218 is located at a remote location and connected to the other elements over a network in certain exemplary embodiments. Further, one or more embodiments is implemented on a distributed system having one or more nodes, where each portion of the implementation (e.g., control engine 106) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

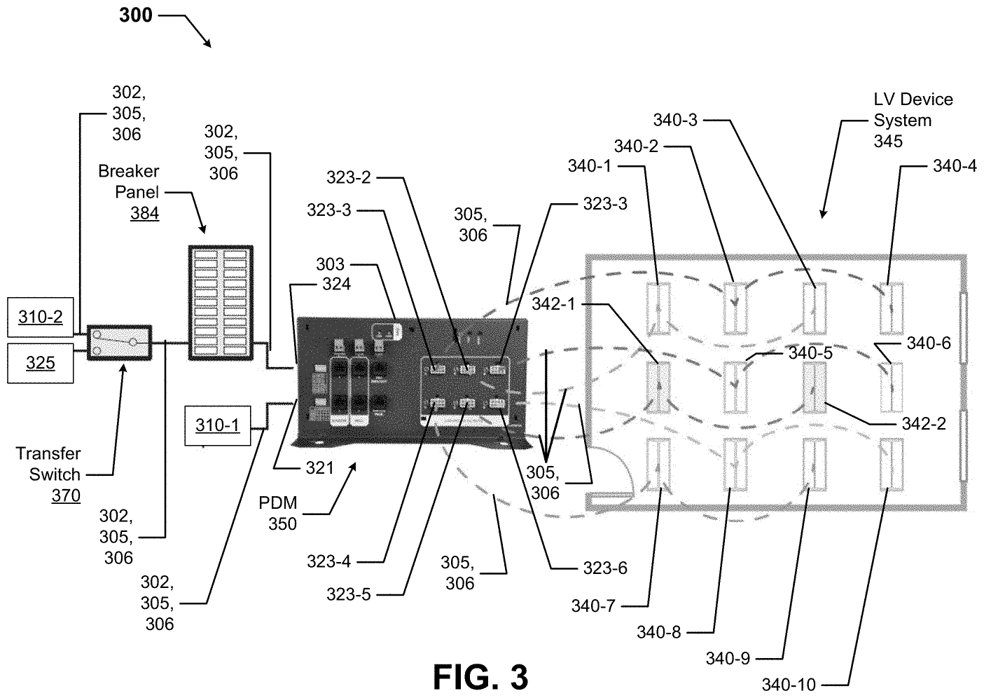

FIG. 3 shows a system diagram of another hybrid distributed low voltage power system 300 in accordance with certain example embodiments. Referring to FIGS. 1A through 3, the components of the system 300 of FIG. 3 are substantially the same as the corresponding components of the system 100 of FIGS. 1A and 1B, except as described below. For example, the system 300 of FIG. 3 includes a LV device system 345 having a total of 12 LV devices (in this case, all light fixtures) disposed in a room or other volume of space. Of the 12 LV devices, there are 10 non-critical LV devices 340 (non-critical LV device 340-1, non-critical LV device 340-2, non-critical LV device 340-3, non-critical LV device 340-4, non-critical LV device 340-5, non-critical LV device 340-6, non-critical LV device 340-7, non-critical LV device 340-8, non-critical LV device 340-9, and non-critical LV device 340-10) and 2 critical LV devices 342 (critical LV device 342-1 and critical LV device 342-2).

The system 300 of FIG. 3 also includes a PDM 350 having six output channels 323 (output channel 323-1, output channel 323-2, output channel 323-3, output channel 323-4, output channel 323-5, and output channel 323-6). Specifically, output channel 323-1, using LV cables 305 and/or communication links 306, provides LV energy to non-critical LV device 340-2 and non-critical LV device 340-4. Output channel 323-2, using LV cables 305 and/or communication links 306, provides LV energy to non-critical LV device 340-1 and non-critical LV device 340-3.

Output channel 323-3, using LV cables 305 and/or communication links 306, provides LV energy to non-critical LV device 340-5 and non-critical LV device 340-6. Output channel 323-4, using LV cables 305 and/or communication links 306, provides LV energy to non-critical LV device 340-7 and non-critical LV device 340-9. Output channel 323-5, using LV cables 305 and/or communication links 306, provides LV energy to critical LV device 342-1 and critical LV device 342-2. Output channel 323-6, using LV cables 305 and/or communication links 306, provides LV energy to non-critical LV device 340-7 and non-critical LV device 340-9.

The PDM 350 of the system 300 of FIG. 3 also have two input channels (hidden from view). One input channel 321 is coupled to a primary power source 310-1 using line voltage cables 102, LV cables 305, and/or communication links 306. The other input channel 324 is coupled to a circuit breaker panel 384 using line voltage cables 102, LV cables 305, and/or communication links 306. The circuit breaker panel 384, in turn, is coupled to a transfer switch 370 using line voltage cables 102, LV cables 305, and/or communication links 306. The transfer switch 370, in turn, is coupled to another primary power source 310-2 and a secondary power source 325. In this case, the transfer switch 370 is a dipole switch, where one pole is coupled to the secondary power source 325 and the other pole is connected to primary power source 310-2. In other embodiments, the switch 370 can have 3 or more poles, where each pole is coupled to a different source of power.

In some cases, the PDM 350 can include a controller (hidden from view, but equivalent to the controller 104 of the PDM 150 of FIGS. 1A and 1B) that controls the position of the switch 370, which in this case is external to the housing 303 of the PDM 350. In other cases, the switch 370 can include a sensor and/or other components that allow the switch 370 to automatically change state or position when a source of power (e.g., primary power source 310-2) is interrupted.

When the switch 370 is in a normal (default) position, as shown in FIG. 3, primary power source 310-2 provides LV energy to the PDM 350 for use by the critical LV devices 342-1 and 342-2, while primary power source 310-1 provides power to the PDM 350 for use by the non-critical LV devices 340-1 through 340-10. In other words, during normal operations, the LV energy provided by primary power source 310-2 is directed by the PDM 350 to output channel 323-5, and the LV energy provided by primary power source 310-1 is directed by the PDM 350 to output channel 323-1, output channel 323-2, output channel 323-3, output channel 323-4, and output channel 323-6.

When the primary power sources 310 stop providing LV energy, initiating an outage condition, the controller of the PDM 350 operates the switch 370 (and in some cases also turns on the secondary power source 325) so that the secondary power source 325 provides LV energy to the PDM 350 for use by the critical LV devices 342-1 and 342-2 through output channel 323-5. In other cases, when the primary power sources 310 stop providing LV energy, the switch 370 operates automatically (without control from the PDM 350) so that the secondary power source 325 feeds the PDM 350 through the breaker panel 384. In such a case, the non-critical LV devices 340-1 through 340-10 do not receive any LV energy and are inactive during the outage of the primary power sources 310.

When one or both of the primary power sources 310 resume providing LV energy, the controller of the PDM 350 can again operate the switch 370 (or the switch 370 can operate automatically) so that the secondary power source 325 no longer provides LV energy to the PDM 350 for use by the critical LV devices 342-1 and 342-2, in some cases also turning off the secondary power source 325. Simultaneously, when the switch is operated, primary power source 310-2 again provides LV energy to the PDM 350 for use by the critical LV devices 342-1 and 342-2, while primary power source 310-1 again provides power to the PDM 350 for use by the non-critical LV devices 340-1 through 340-10.

In some cases, an additional switch 370 can be disposed within the housing 303 of the PDM 350. In such a case, if one of the primary power sources 310 (e.g., primary power source 310-2) fails while the other primary power source 310 (e.g., primary power source 310-1) continues to operate, the controller of the PDM 350 can operate the switch 370 internal to the PDM 350 while keeping the switch 370 shown in FIG. 3 in the same state. In this way, primary power source 310-1 can provide power to all of the LV devices, including the critical LV devices 342-1 and 342-2, while primary power source 310-2 is unavailable and while primary power source 310-1 remains available.

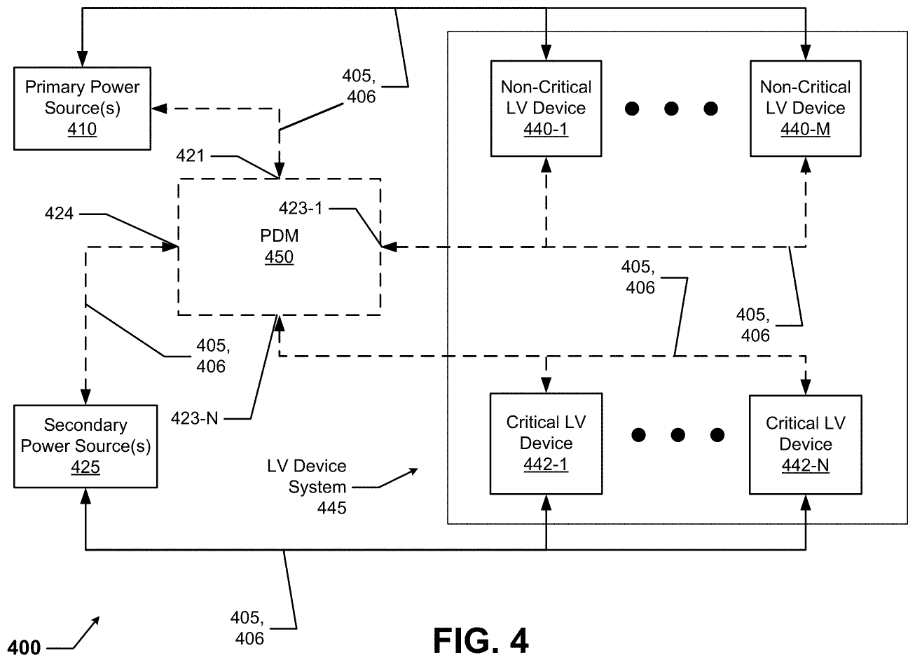

FIG. 4 shows yet another system diagram of another hybrid distributed low voltage power system 400 in accordance with certain example embodiments. Referring to FIGS. 1A through 4, the components of system 400 of FIG. 4 are substantially the same as the corresponding components of the systems of FIGS. 1A, 1B, and 3, except as described below. In this case, the system 400 of FIG. 4 includes one or more primary power sources 410, one or more secondary power sources 325, a LV device system 445, and an optional PDM 450. The LV device system 445 includes one or more non-critical LV devices 440 (e.g., non-critical LV device 440-1, non-critical LV device 440-M) and one or more critical LV devices 442 (e.g., critical LV device 442-1, critical LV device 442-N).

In the system 400 of FIG. 4, there are no switches. Without the PDM 450 (in other words, when the optional PDM 450 is not included in the system 450), the one or more primary power sources 410 are directly coupled to the non-critical LV devices 440 of the LV device system 445 using LV cables 405 and/or communication links 406. Similarly, the one or more secondary power sources 425 are directly coupled to the critical LV devices 442 of the LV device system 445 using LV cables 405 and/or communication links 406.

As a result, under this configuration, each of the secondary power sources 425 are always providing LV energy to the critical LV devices 442, regardless of whether the primary power sources 410 are providing LV energy to the non-critical LV devices 440. This differs from the configurations of the systems of FIGS. 1A and 3, where the secondary power sources only provide LV energy to the critical LV devices when the primary power sources cease to deliver LV energy to those critical LV devices. The switches of these previously-discussed embodiments were used to engage the secondary power sources with the critical LV devices when one or more of the primary power sources are in an outage condition.

Returning to the system 400 of FIG. 4, when the PDM 450 is part of the system 400, the LV energy sent by the primary power sources 410 and the secondary power sources 425 can be routed directly to the non-critical LV devices 440 and the critical LV devices 442, respectively, without re-routing the LV energy. The LV energy from the primary power sources 410 is received by the PDM 450 at the one or more input channels 421 through LV cables 405 and/or communication links 406. This LV energy is then sent out of one or more output channels 423 (e.g., output channel 423-1) through LV cables 405 and/or communication links 406 to the non-critical LV devices 440.

Similarly, the LV energy from the secondary power sources 425 is received by the PDM 450 at the one or more input channels 424 through LV cables 405 and/or communication links 406. This LV energy is then sent out of one or more different output channels 423 (e.g., output channel 423-N) through LV cables 405 and/or communication links 406 to the critical LV devices 442.

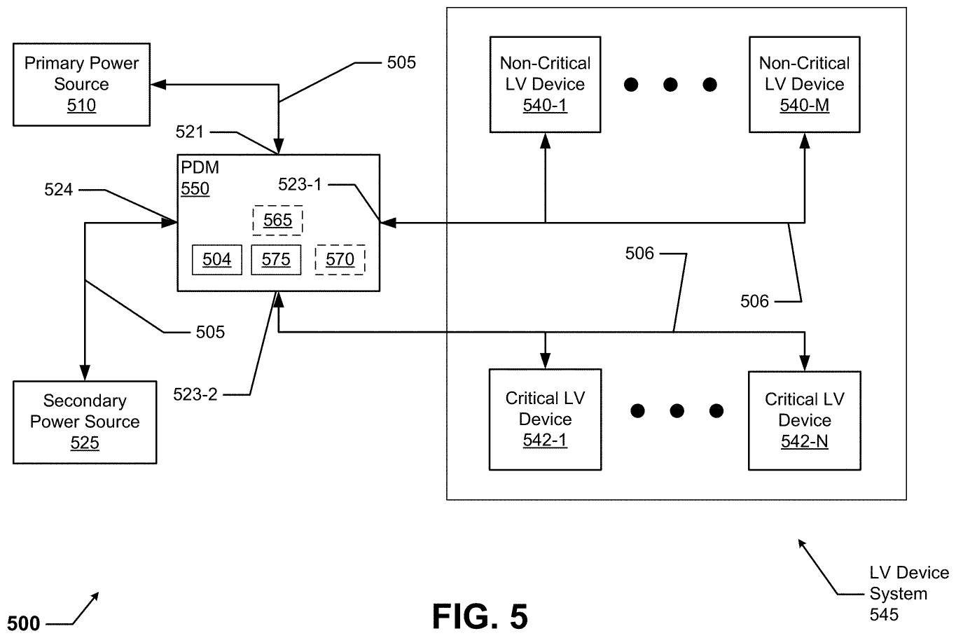

FIG. 5 shows a system diagram of still another controlled hybrid distributed low voltage power system in accordance with certain example embodiments. Referring to FIGS. 1A through 5, the components of system 500 of FIG. 5 are substantially the same as the corresponding components of the systems of FIGS. 1A, 1B, 3, and 4, except as described below. In this case, the system 500 of FIG. 5 includes a PDM 550 that acts as a POE switch. The PDM 550 includes a controller 504, an optional power transfer device 565, a power supply 575, and at least one optional switch 570. A primary power source 510 provides power (e.g., LV energy) to an input channel 521 of the PDM 550 through a LV cable 505. A secondary power source 525 provides power (e.g., LV energy) to another input channel 524 of the PDM 550 through another LV cable 505. In some cases, the LV cables 505 of FIG. 5 can be replaced with line voltage cables (e.g., line voltage cables 102).

The system 500 of FIG. 5 also includes a LV device system 545 that is connected to multiple output channels 523 of the PDM 550. The LV device system 545 includes one or more non-critical LV devices 540 (e.g., non-critical LV device 540-1, non-critical LV device 540-M) and one or more critical LV devices 542 (e.g., critical LV device 542-1, critical LV device 542-N). The PDM 550 delivers LV energy through output channel 523-1 to the non-critical LV devices 540 through a communication link 506, which in this case are one or more Ethernet cables. Also, the PDM 550 delivers LV energy through output channel 523-2 to the critical LV devices 542 through another communication link 506, which in this case are one or more Ethernet cables.

Example embodiments provide a number of benefits. Examples of such benefits include, but are not limited to, reduction in energy usage; increased reliability during outages and other emergency conditions, simplistic integration into existing systems (with or without a secondary power source); simplified maintenance; qualification as a Class 2 device and/or system; compliance with one or more applicable standards and/or regulations; less need for licensed electricians; reduced downtime of equipment; lower maintenance costs; prognosis of equipment failure; improved maintenance planning; and reduced cost of labor and materials. Example embodiments can also be integrated (e.g., retrofitted) with existing systems.

Example embodiments are electrically safe. Example systems or any portion thereof can be free from risk (or a greatly reduced risk) of fire or electrical shock for any user installing, using, replacing, and/or maintaining any portion of example embodiments. For example, the LV energy that feed a device can allow a user to maintain the device without fear of fire or electrical shock. While Class 2 systems and SELV/PELV/FELV are described above, example embodiments can comply with one or more of a number of similar standards and/or regulations throughout the world. Example embodiments can be used to implement intelligent load management strategies.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A hybrid distributed low voltage power system, comprising:
a primary power source that distributes a first low voltage (LV) energy during a first mode of operation to a plurality of first LV devices of a LV device system and fails to distribute the first LV energy to the plurality of first LV devices during a second mode of operation; and
a secondary power source that distributes a second LV energy to at least one second LV device of the LV device system during the first mode of operation and during the second mode of operation,
wherein the plurality of first LV devices are not critical during the second mode of operation,
wherein the at least one second LV device is critical during the second mode of operation.

2. The hybrid distributed low voltage power system of claim 1, further comprising:
a power distribution module (PDM) comprising:
a first input channel coupled to the primary power source;
a second input channel coupled to the secondary power source;
a plurality of first output channels coupled to the plurality of first LV devices; and
at least one second output channel coupled to the at least one second LV device.

3. The hybrid distributed low voltage power system of claim 1, wherein the second mode of operation is a power outage, wherein the first power source fails to provide the first LV energy during the power outage.

4. The hybrid distributed low voltage power system of claim 1, wherein the first LV energy is direct current power.

5. The hybrid distributed low voltage power system of claim 1, wherein each first LV device of the plurality of first LV devices qualifies as a Class 2 device.

6. A hybrid distributed low voltage power system, comprising:
a primary power source that distributes a low voltage (LV) energy during a first mode of operation to a plurality of LV devices and fails to distribute the LV energy to the plurality of LV devices during a second mode of operation;
a secondary power source that distributes the LV energy to at least one of the plurality of LV devices during the second mode of operation and fails to distribute the LV energy to the at least one of the plurality of LV devices during the first mode of operation; and
at least one switch coupled to the primary power source and the secondary power source, wherein the at least one switch operates in a first position to allow the secondary power source to deliver the LV energy to the at least one of the plurality of LV devices during the second mode of operation, and wherein the at least one switch further operates in a second position to prevent the secondary power source from delivering the LV energy to the at least one of the plurality of LV devices during the first mode of operation.

7. The hybrid distributed low voltage power system of claim 6, wherein the at least one switch further operates to allow the primary power source to deliver the LV energy to the plurality of LV devices during the first mode of operation, and wherein the switch further operates to prevent the primary power source from delivering the LV energy to the plurality of LV devices during the second mode of operation

8. The hybrid distributed low voltage power system of claim 6, further comprising:
a power distribution module (PDM) comprising:
a first input channel coupled to the primary power source;
a second input channel coupled to the secondary power source;
at least one first output channel coupled to the at least one of the plurality of LV devices; and
at least one second output channel coupled to a remainder of the plurality of LV devices.

9. The hybrid distributed low voltage power system of claim 8, further comprising:
a plurality of LV cables that delivers the LV power from the at least one first output channel and the at least one second output channel of the PDM to the plurality of LV devices.

10. The hybrid distributed low voltage power system of claim 9, wherein the PDM is a power over Ethernet switch, and wherein the plurality of LV cables comprises Ethernet cable.

11. The hybrid distributed low voltage power system of claim 8, further comprising:
a controller configured to operate the at least one switch.

12. The hybrid distributed low voltage power system of claim 11, wherein the controller is part of the PDM.

13. The hybrid distributed low voltage power system of claim 12, wherein the PDM further comprises at least one sensor that measures a power parameter, wherein the controller determines that the power parameter falls below a threshold value, thereby ending the first mode of operation.

14. The hybrid distributed low voltage power system of claim 13, wherein the controller operates the at least one switch into the first position when the first mode of operation ends and the second mode of operation begins.

15. The hybrid distributed low voltage power system of claim 14, wherein the controller operates the at least one switch into the second position when the power parameter measured by the at least one sensor falls above a threshold value, thereby resuming the first mode of operation.

16. A low voltage power distribution module, comprising:
a first input channel configured to couple to a primary power source during a first mode of operation;
a second input channel configured to couple to a secondary power source during a second mode of operation;
a first output channel configured to send a first low voltage (LV) energy, based on a first input received from the primary power source, to at least one first LV device during the first mode of operation; and
a second output channel configured to send a second LV energy, based on a second input received from the secondary power source, to at least one second LV device during the second mode of operation.

17. The low voltage power distribution module of claim 16, wherein the first input is the first LV energy, and wherein the second input is the second LV energy.

18. The low voltage power distribution module of claim 16, further comprising:
a power transfer device configured to:
receive the first input from the first input channel;
generate the first LV energy using the first input; and
deliver the first LV energy to the first output channel.

19. The low voltage power distribution module of claim 18, wherein the power transfer device is further configured to:
receive the second input from the second input channel;
generate the second LV energy using the second input; and
deliver the second LV energy to the second output channel.

20. The low voltage power distribution module of claim 16, further comprising:
at least one switch coupled to and disposed between the first input channel, the second input channel, and the second output channel, wherein the at least one switch has a first position and a second position, wherein the switch, when in the first position, provides continuity between the first input channel and the second output channel during the first mode of operation, and wherein the switch, when in the second position, provides continuity between the second input channel and the second output channel during the second mode of operation.
